(19) United States
(12) Patent Application Publication
(10) Pub. No.: US 2026/0310446 A1
(43) Pub. Date: Oct. 8, 2026

(54) MINIMIZED DOWNTIME OPERATIONS (MDO) FOR SAP SOFTWARE SOLUTIONS

(71) Applicant: LEMONGRASS HOLDINGS, INC., Ewing, NJ (US)

(72) Inventors: Frank STIENHANS, Belmont, CA (US); Damian AUSTEN, Derby, Derbyshire (GB); Rob SHERWOOD, Farnborough, Hampshire (GB)

(73) Assignee: LEMONGRASS HOLDINGS, INC., Ewing, NJ (US)

(21) Appl. No.: 19/482,632

(22) PCT Filed: May 7, 2024
(86) PCT No.: PCT/US2024/028094

§ 371 Date: Nov. 7, 2025

Related U.S. Application Data
(60) Provisional application No. 63/501,253, filed on May 10, 2023.

(51) Int. Cl. G06F 8/656; G06F 16/178

(52) U.S. Cl. CPC G06F 8/656; G06F 16/178

(57) ABSTRACT

A server system identifies an active computing environment. The active computing environment includes one or more files. The active computing environment is selected from a group comprising an SAP HANA instance, an SAP application server instance, or an SAP central service instance. The server system generates a target computing environment corresponding to the active computing environment. The target computing environment is substantially similar to the active computing environment. The server system synchronizes files from the active computing environment to the target computing environment. The server system routes users from the active computing environment to the target computing environment following synchronization of the files from the active computing environment to the target computing environment with minimal downtime.

### CROSS-REFERENCE TO RELATED APPLICATIONS

This application claims priority to U.S. Provisional Application Ser. No. 63/501,253, filed May 10, 2023, which is hereby incorporated by reference in its entirety.

### FIELD

The field generally relates to information processing systems, particularly Operating Systems (OS) and Databases (DB) running SAP NetWeaver-based application systems developed by SAP AG.

### BACKGROUND

The process for certain SAP system operation activities results in significant downtime while the system operator administers the activities. Because of this downtime, business users may be inhibited from performing their activities and may not have access to the data they need. In some cases, significant testing must also be performed before releasing the system to the end users, which further increases the impact of these activities on the business users.

### SUMMARY

In some embodiments, an apparatus comprises at least one processing device coupled to Random Access Memory (RAM). The at least one processing device, referred to as the first server, runs an SAP Application Server or a DB. A new apparatus comprising at least one processing device coupled to RAM referred to as the second server is deployed. The second server is configured with the OS image matching with the to-be state after the change. The second server is further configured with the DB and/or SAP application configuration and other associated changes as part of the change activity. It is further configured to synchronize the data from the first server.

These and other illustrative embodiments include, without limitation, apparatus, systems, methods, and processor-readable media.

In some embodiments, a method is disclosed herein. A server system identifies an active computing environment. The computing environment includes one or more files. The active computing environment is selected from a group comprising an SAP HANA instance, an SAP application server instance, or an SAP central service instance. The server system generates a target computing environment corresponding to the active computing environment. The target computing environment is substantially similar to the active computing environment. The server system synchronizes files from the active computing environment to the target computing environment. The server system routes users from the active computing environment to the target computing environment following synchronization of the files from the active computing environment to the target computing environment with minimal downtime.

In some embodiments, a non-transitory computer readable medium is disclosed herein. The non-transitory computer readable medium includes one or more sequences of instructions, which, when executed by a processor, causes the server system to perform operations. The operations include identifying an active computing environment. The active computing environment includes one or more files. The active computing environment is selected from a group comprising an SAP HANA instance, an SAP application server instance, or an SAP central service instance. The operations further include generating a target computing environment corresponding to the active computing environment. The target computing environment is substantially similar to the active computing environment. The operations further include synchronizing files from the active computing environment to the target computing environment. The operations further include routing users from the active computing environment to the target computing environment following synchronization of the files from the active computing environment to the target computing environment with minimal downtime.

In some embodiments, a system is disclosed herein. The system includes a processor and a memory. The memory has programming instructions stored thereon, which, when executed by the processor, causes the system to perform operations. The operations include identifying an active computing environment. The active computing environment includes one or more files. The active computing environment is selected from a group comprising an SAP HANA instance, an SAP application server instance, or an SAP central service instance. The operations further include generating a target computing environment corresponding to the active computing environment. The target computing environment is substantially similar to the active computing environment. The operations further include synchronizing files from the active computing environment to the target computing environment. The operations further include routing users from the active computing environment to the target computing environment following synchronization of the files from the active computing environment to the target computing environment with minimal downtime.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating the information processing operations across Active and Inactive sites to achieve minimal downtime, according to example embodiments.

FIG. 2 is a chart illustrating a fail-forward diagram between active computing environment and target computing environment, according to example embodiments.

FIG. 3 is a chart illustrating a fail-forward diagram between multiple active computing environments and multiple target computing environments, according to example embodiments.

FIG. 4 is a block diagram comparing the conventional approach of in-place patching of an operating system and/or database compared to use of a fail forward service, according to example embodiment.

FIG. 5 is a block diagram comparing the conventional approach of SAP system refresh compared to use of a fail forward service, according to example embodiment.

FIG. 6 is a flow diagram illustrating a method of reducing system downtime in an SAP system, according to example embodiments.

FIG. 7A is a block diagram illustrating a computing device, according to example embodiments of the present disclosure.

FIG. 7B is a block diagram illustrating a computing device, according to example embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments disclosed herein generally relate to an improved method for operating SAP software solutions with minimal downtime. It is to be noted that SAP AG provides a standard set of tools to operate its software, which in its traditional embodiment requires that the application and the underlying database be stopped for certain operations, such as security patches to the software, operating system upgrades, scaling the system to support growing demand, and the like. As a result of this, end users frequently incur SAP application downtime during such operations. Because SAP systems are often part of the core business processes of SAP's customers, every second of downtime of SAP systems often leads to significant costs for SAP's customers.

Common best practices to minimize or reduce the downtime of such operations often rely on a few ways to reduce or avoid planned system downtimes, namely a) infrastructure, b) the ability to install and configure the failed software or hardware component quickly, c) end-to-end automation for time-critical work, and d) well-designed software to allow replacement without downtime. SAP AG, the developer of the SAP application software solution, controls the source code and without the option to modify the code, it is harder to achieve near-zero downtime for operations.

To address the limitations of SAP's system, one or more embodiments described herein provide an improved approach for minimizing downtime for planned actions such as deployment, patching, scaling, replacement, upgrade, and configuration of services such as storage sub-systems, operating systems, databases, SAP ABAP Central Services (ASCS), and SAP Application Servers. For example, one or more techniques disclosed herein minimizes the downtime for planning actions by creating a new target environment for each operation performed in the existing target environment. Once the new target environment is tested to ensure that it can replicate the performance of the existing target environment, traffic may be re-routed from the existing target environment to the new target environment with minimal, or in some cases zero, downtime.

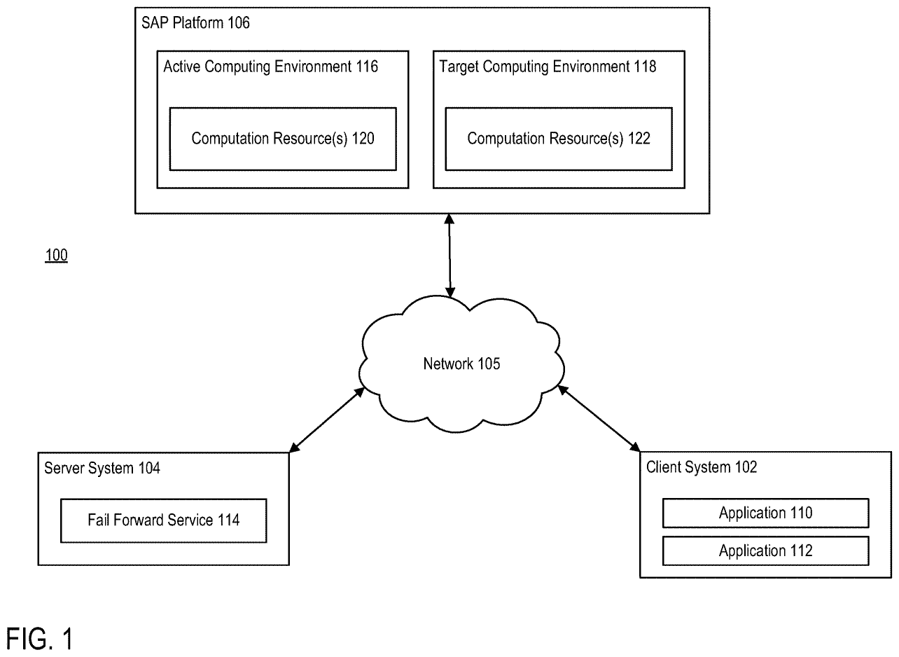

FIG. 1 is a block diagram illustrating a computing environment 100, according to example embodiments. Computing environment 100 may include client system 102, server system 104, and SAP platform 106 communicating via network 105.

Network 105 may be representative of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may be representative of the Internet, a private data network, virtual private network using a public network and/or other suitable connection(s) that enables components in computing environment 100 to send and receiving information between the components of computing environment 100.

Client system 102 may be operated by a user. In some embodiments, client system 102 may represent devices of users that are associated with or subscribed to services offered by an entity associated with server system 104. In some embodiments, client system 102 may be representative of one or more computing devices, such as, but not limited to, a mobile device, a tablet, a personal computer, a laptop, a desktop computer, or, more generally, any computing device or system having the capabilities described herein.

Client system 102 may include application 110 and application 112. Application 110 may be representative of a web browser that allows access to a website or a stand-alone application. Client system 102 may access application 110 to access one or more functionalities of SAP platform 106. Client system 102 may communicate over network 105 to request a webpage, for example, from a web client application server of SAP platform 106. In some embodiments, a user of client system 102 may access application 110 to access various services made available by SAP platform 106. For example, client system 102 may use application 110 to access one or more of SAP HANA, SAP application servers, and/or SAP central services.

Application 112 may be representative of a web browser that allows access to a website or a stand-alone application. Client system 102 may access application 112 to access one or more functionalities of server system 104. Client system 102 may communicate over network 105 to request a webpage, for example, from a web client application server of server system 104. In some embodiments, a user of client system 102 may access application 112 to access functionality of server system 104, such as, but not limited to, fail forward service 114.

SAP platform 106 may generally refer to a system associated with SAP AG. In some embodiments, SAP platform 106 may be representative of a combination of physical and/or virtual computing resources. As shown, SAP platform 106 may include an active computing environment 116 and a target computing environment 118.

Active computing environment 116 may represent the current computing environment with which the user is currently interacting. As shown, active computing environment 116 may include one or more computation resources 120 or services. In some embodiments, exemplary computation resources may include data base management systems (DBMS), a database, an SAP application server, SAP central services, and the like. Client system 102 may be configured to perform one or more actions on the computation resources 120 or services. Exemplary actions may include, but are not limited to, build actions, patch actions (e.g., patch one or more of operating system, database, application), change configuration (e.g., change configuration of one or more of storage, operating system, database, application), upgrade, scale, hardware refresh, and system refresh. Given computation resources 120 and the actions, the number of possible atomic operations in active computing environment 116 may be represented by services. actions. Further, as those skilled in the art understand, several operations may be combined into one or more composite operations. Thus, the number of possible atomic operations may exceed services. actions.

Referring to server system 104, server system 104 may be representative of one or more computing systems configured to interface with SAP platform 106. For example, server system 104 may provide users of client system 102 with an integration for minimizing downtime of their SAP systems. Server system 104 may include a fail forward service 114. Fail forward service 114 may be comprised of one or more software modules. The one or more software modules can be collections of code or instructions stored on a media (e.g., memory of server system 104) that represent a series of machine instructions (e.g., program code) that implements one or more algorithmic steps. Such machine instructions may be the actual computer code the processor of server system 104 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

Fail forward service 114 may be configured to reduce the overall downtime in a user's or client's SAP system by building a new target environment for planned operations. For example, fail forward service 114 may be configured to monitor a user's SAP platform 106 and generate or build a new target environment based on the requirements described by the monitored operation. In some embodiments, each operation may cause fail forward service 114 to generate a new build of a database System or an SAP System. Such operations traditionally required a significant effort to build and test based on the existing methods. With fail forward service 114, however, the build process is automated, and testing may be done online on the new target environment at the inactive site while the production business application is still running at the active site. Once the new site has been tested, the productive system at the active site may fail over to the newly built environment at the inactive site with minimal business downtime. The inactive site then becomes the active site.

Referring back to SAP platform 106, SAP platform 106 may further include target computing environment 118. Target computing environment 118 may be generated responsive to fail forward service 114 detecting an operation or composite operation that would trigger the process for a new build. Fail forward service 114 may generate a new build of the database system or SAP system in the form of target computing environment 118. As shown, target computing environment 118 may include computation resources 122, substantially similar to computation resources 120. Fail forward service 114 may be configured to test target computing environment 118 to ensure that it is at least as reliable as active computing environment 116. Once testing is complete, traffic may be routed away from active computing environment 116 to target computing environment 118, thus activating target computing environment 118.

In this manner, fail forward service 114 may allow systems configured for maximum uptime to be prepared to failover into inactive at any time. High availability is thereby ensured by establishing redundancy between active computing environment 116 and target computing environment 118. At every point in time, active computing environment 116 may have another site (e.g., target computing environment 118) to failover to, thereby achieving high system uptime in any situation.

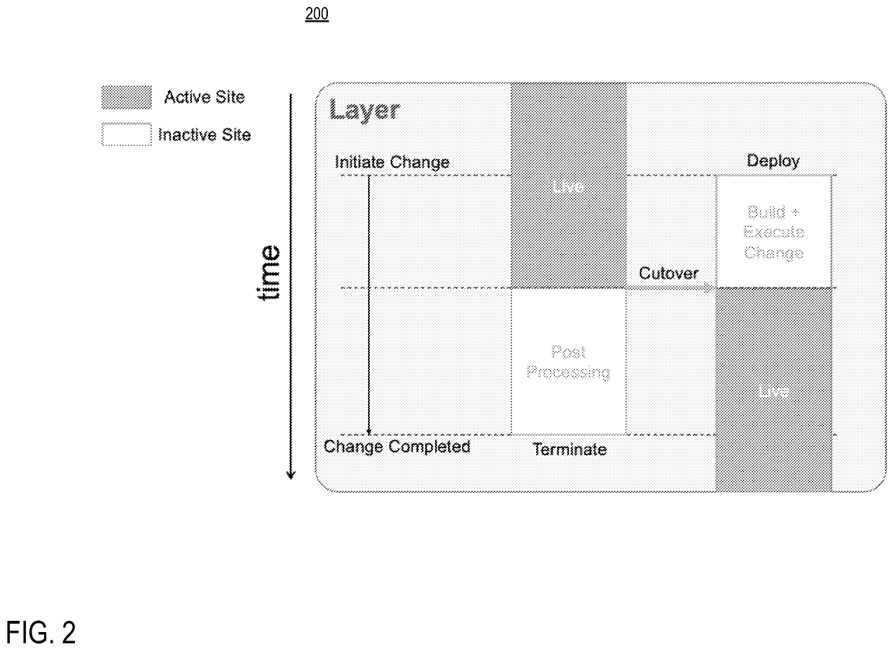

FIG. 2 is a chart illustrating a fail-forward diagram 200 between active computing environment 116 and target computing environment 118, according to example embodiments.

Generally, each operation may follow a homogeneous approach, enabling one standard procedure (automated or manual or a mix of both). Such approach may lead to a high test coverage even though the number of possible operations is very large, as previously discussed.

As shown, fail-forward diagram 200 may include activities at active computing environment 116. During the live period (i.e., the period in which active computing environment 116 is active), fail forward service 114 may build a new target environment (e.g., target computing environment 118). Fail forward service 114 may test target computing environment 118 to ensure that the same technologies present in active computing environment 116 are also present in target computing environment 118 to ensure high availability. As those skilled in the art understand, a failure of such complex operations as patching, upgrading, or scaling cannot lead to unexpected business downtime. Accordingly, in some embodiments, fail forward service 114 may test each operation in target computing environment 118 to ensure business continuity between active computing environment 116 and target computing environment 118. In contrast to the existing practice and documented best practices by SAP, even during a change operation, this improved method guarantees the same uptime SLA. Once target computing environment 118 has been sufficiently tested, traffic may be re-routed to target computing environment 118.

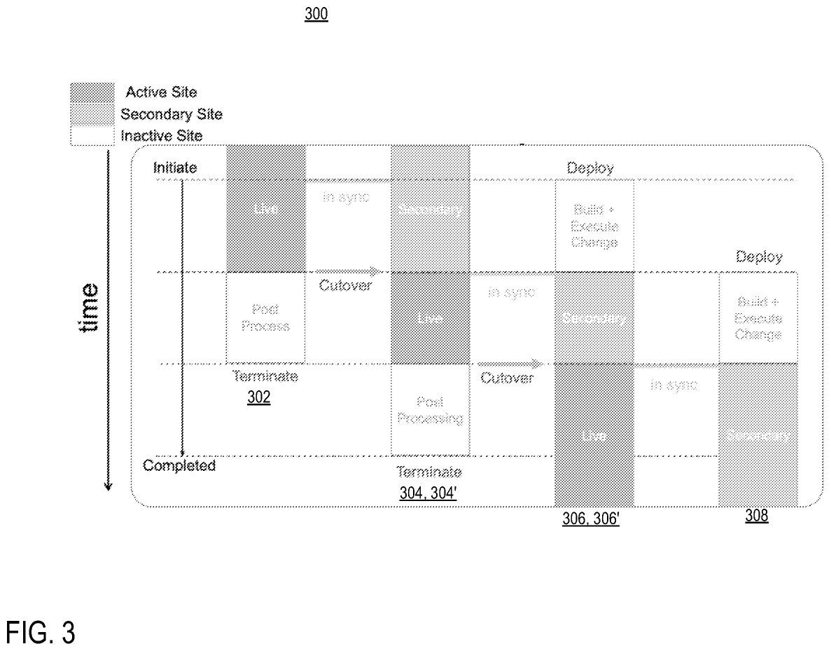

FIG. 3 is a chart illustrating a fail-forward diagram 300 between multiple active computing environments and multiple target computing environments, according to example embodiments.

As shown, fail-forward diagram 300 may include multiple active and target computing environments based on operations performed by a user in a given active computing environment. For example, assume fail-forward diagram 300 includes a first active computing environment 302. During the live period (i.e., the period in which first active computing environment 302 is active), fail forward service 114 may build a new target environment (e.g., target computing environment 304) responsive to detecting a new operation. Fail forward service 114 may test first target computing environment 304 to ensure that the same technologies present in first active computing environment 302 are also present in first target computing environment 304 to ensure high availability.

Once first target computing environment 304 becomes an active computing environment (e.g., second active computing environment 304′), fail forward service 114 may build a new target environment (e.g., second target computing environment 306) responsive to detecting a new operation at second active computing environment 304′. Fail forward service 114 may test second target computing environment 306 to ensure that the same technologies present in second active computing environment 304′ are also present in second target computing environment 306 to ensure high availability.

Once second target computing environment 306 becomes an active computing environment (e.g., third active computing environment 306′), fail forward service 114 may build a new target environment (e.g., third target computing environment 308) responsive to detecting a new operation at third active computing environment 306′. Such process may repeat continuously to ensure high availability and minimal downtime of computing resources.

In some embodiments, the foregoing functionality of every service may require a different architecture and design. Each service may implement the fail-forward pattern differently.

Databases running SAP systems support near-zero downtime failover as part of its high availability best practices using native database replication technology. For example, SAP HANA System Replication (HSR) continuously replicates data from one HANA database to another. Existing toolsets offer database clustering, allowing immediate network failover. Using the improved failover approach, a new database system is built with the desired change specification, and the database replication process is activated. Once the databases at the active computing environment and the target computing environments are synchronized, the fail-forward trigger can move existing users seamlessly from active computing environment to target computing environment with near-zero downtime and initiate abandonment of the infrastructure at the old site.

This improved approach can be applied to achieve near-zero downtime to several common IT operations to SAP Application Servers management, namely for upgrading or patching the underlying OS, vertically scaling the underlying infrastructure components like Computer Processing Unit (CPU), RAM, and storage, changing the underlying hardware, and patching SAP kernel. To implement the minimized downtime approach, fail forward service may deploy an SAP application server with the new configuration, and the appropriate files are synced from the original server to the new application server. The fail-forward mechanism triggers the automatic shutdown of the original server, reconfigures the network to route the users to the new SAP application server, and finally brings up the new application server with minimal downtime for the users.

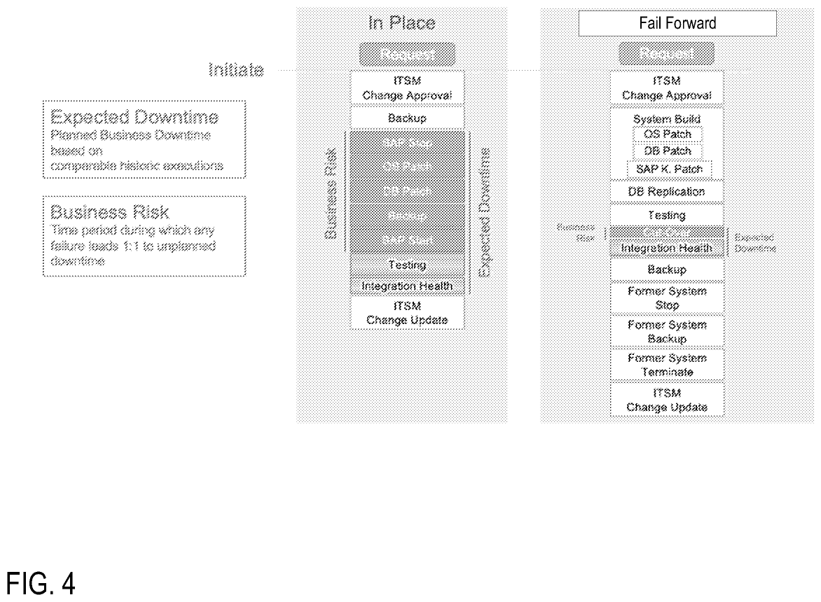

FIG. 4 is a block diagram comparing the conventional approach of in-place patching of an operating system and/or database compared to use of fail forward service 114, according to an example embodiment. In this example scenario of in-place patching, activities such as stopping SAP, patching of OS and DB, backup, starting of SAP, testing, and integration health check happen during the overall application downtime resulting in significant business risk due to unforeseen failures. With the improved method, several activities are done outside of the downtime window reducing the overall business loss and business risk.

The foregoing functionality also supports near-zero downtime upgrade or patching of the underlying OS, vertically scaling of the underlying infrastructure components, change of the underlying hardware, and patching of the SAP kernel for the ASCS instance. To achieve minimal downtime for these operations, a new ASCS instance with the changed configuration is deployed together with SAP Enqueue Replication Services (ERS) when no ERS instance is available in the system landscape. When necessary, OS-native clustering technology is implemented for fail-over from one server to another. The entries from the lock table in the ASCS instance are synchronized with the replicated lock table in the ERS instance. Additional files from the original server are also synchronized to the new ASCS server. The fail-forward mechanism then triggers the fail-over to the new instantiated ASCS server while the users are actively working in the system.

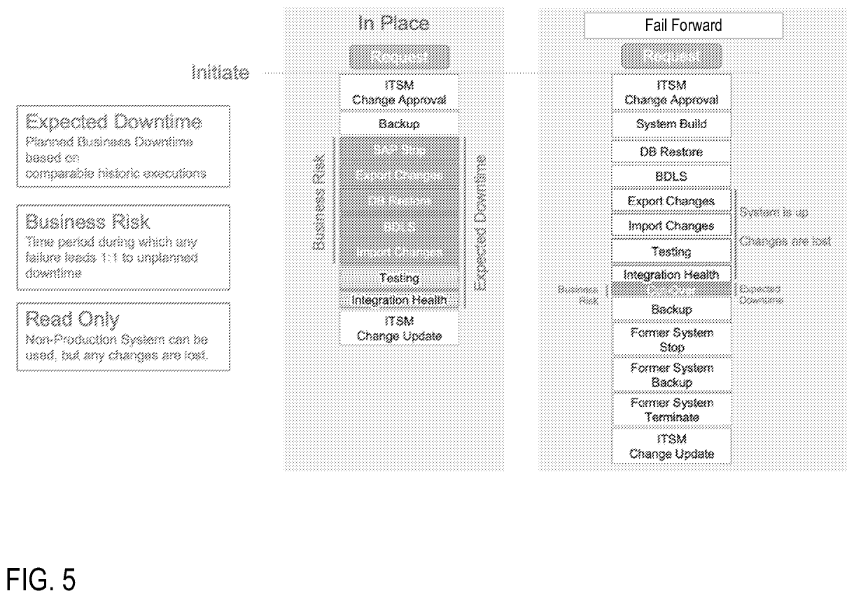

FIG. 5 is a block diagram comparing the conventional approach of in-place SAP system refresh compared to use of fail forward service 114, according to example embodiment.

SAP system refresh is another example of possible actions of this improved method for minimized downtime operations. In SAP system refreshes, an existing system, referred to as the target system, is replaced with a copy of another system, referred to as the target system. In the illustrative embodiment of FIG. 5, the existing SAP system refresh is compared with the improved method. Various refresh activities such as stopping and starting of the system, export and import of certain changes, database restore, testing, and integration checks are done during downtime when the target system is down for business users. As shown in FIG. 5, such activities are done in a completely new system, referred to as the new target system, with no downtime to the original target system. Once the activities are complete, the fail-forward trigger results in network routing changes to move active users from the original target system to the newly built target system resulting in minimal downtime.

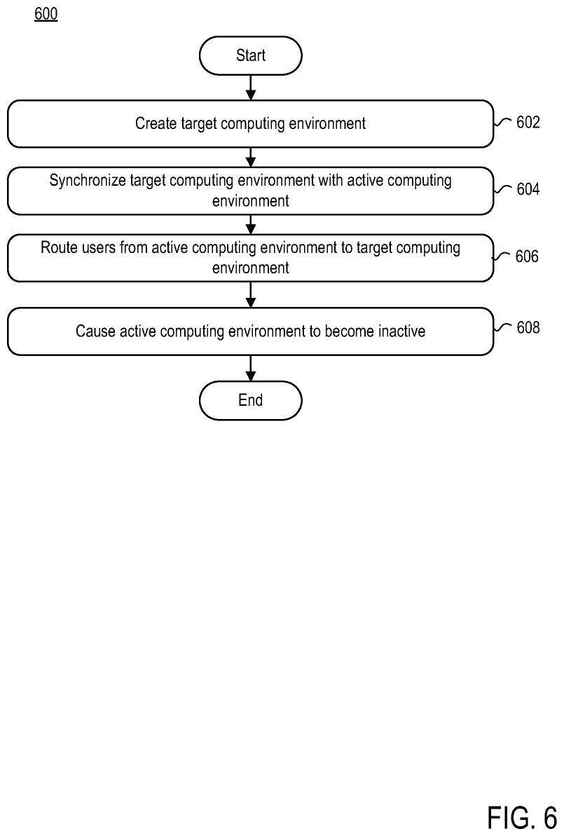

FIG. 6 is a flow diagram illustrating a method 600 of reducing system downtime in an SAP system, according to example embodiments. Method 600 may begin at step 602.

At step 602, server system 104 may create a target computing environment corresponding to an active computing environment. For example, fail forward service 114 may generate a target computing environment that replicates the functionality and/or environment of a current, active computing environment. In some embodiments, fail forward service 114 may create a new SAP HANA instance corresponding to a current, active SAP HANA instance. In some embodiments, fail forward service 114 may create a new database instance corresponding to a current, active database instance. In some embodiments, fail forward service 114 may generate a new SAP application server instance corresponding to a current, active SAP application server instance. In some embodiments, fail forward service 114 may generate a new SAP central service instance corresponding to a current, active SAP central service instance. In some embodiments, the target computing environment may be substantially similar to the active computing environment.

At step 604, server system 104 may synchronize the target computing environment with the active computing environment. For example, once fail forward service 114 generates the target computing environment, fail forward service 114 may synchronize the appropriate files from active computing environment to target computing environment. Such process may ensure a minimized downtime approach moving from active computing environment to target computing environment.

At step 606, server system 104 may route users from the active computing environment to the target computing environment. For example, fail forward service 114 may reconfigure the computing network to route users from the active computing environment to the target computing environment with minimal downtime.

At step 608, server system 104 may cause the active computing environment to shut down or become inactive. For example, following file synchronization and/or routing of users from the active computing environment to the target computing environment, fail forward service 114 may shut down the active computing environment in favour of the target computing environment.

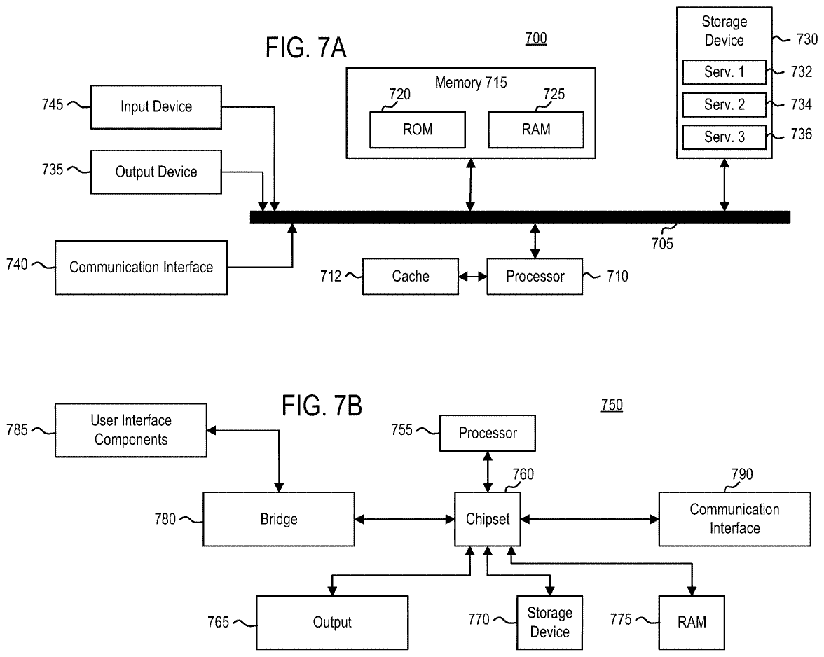

FIG. 7A illustrates a system bus architecture of computing system 700, according to example embodiments. System 700 may be representative of one or more of client system 102, server system 104, and/or SAP platform 106. One or more components of system 700 may be in electrical communication with each other using a bus 705. System 700 may include a processing unit (CPU or processor) 710 and a system bus 705 that couples various system components including the system memory 715, such as read only memory (ROM) 720 and random-access memory (RAM) 725, to processor 710.

System 700 may include a cache of high-speed memory connected directly with, in close proximity to, or integrated as part of processor 710. System 700 may copy data from memory 715 and/or storage device 730 to cache 712 for quick access by processor 710. In this way, cache 712 may provide a performance boost that avoids processor 710 delays while waiting for data. These and other modules may control or be configured to control processor 710 to perform various actions. Other system memory 715 may be available for use as well. Memory 715 may include multiple different types of memory with different performance characteristics. Processor 710 may include any general-purpose processor and a hardware module or software module, such as service 1 732, service 2 734, and service 3 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction with the computing system 700, an input device 745 may represent any number of input mechanisms, such as a microphone for speech, a touch-sensitive screen for gesture or graphical input, keyboard, mouse, motion input, speech and so forth. An output device 735 may also be one or more of a number of output mechanisms known to those of skill in the art. In some instances, multimodal systems may enable a user to provide multiple types of input to communicate with computing system 700. Communications interface 740 may generally govern and manage the user input and system output. There is no restriction on operating on any particular hardware arrangement and therefore the basic features here may easily be substituted for improved hardware or firmware arrangements as they are developed.

Storage device 730 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 725, read only memory (ROM) 720, and hybrids thereof.

Storage device 730 may include services 732, 734, and 736 for controlling the processor 710. Other hardware or software modules are contemplated. Storage device 730 may be connected to system bus 705. In one aspect, a hardware module that performs a particular function may include the software component stored in a computer-readable medium in connection with the necessary hardware components, such as processor 710, bus 705, output device 735 (e.g., display), and so forth, to carry out the function.

FIG. 7B illustrates a computer system 750 having a chipset architecture that may represent one or more of client system 102, server system 104, and/or SAP platform 106. Computer system 750 may be an example of computer hardware, software, and firmware that may be used to implement the disclosed technology. System 750 may include a processor 755, representative of any number of physically and/or logically distinct resources capable of executing software, firmware, and hardware configured to perform identified computations. Processor 755 may communicate with a chipset 760 that may control input to and output from processor 755.

In this example, chipset 760 outputs information to output 765, such as a display, and may read and write information to storage device 770, which may include magnetic media, and solid-state media, for example. Chipset 760 may also read data from and write data to storage device 775 (e.g., RAM). A bridge 780 for interfacing with a variety of user interface components 785 may be provided for interfacing with chipset 760. Such user interface components 785 may include a keyboard, a microphone, touch detection and processing circuitry, a pointing device, such as a mouse, and so on. In general, inputs to system 750 may come from any of a variety of sources, machine generated and/or human generated.

Chipset 760 may also interface with one or more communication interfaces 790 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 755 analyzing data stored in storage device 770 or storage device 775. Further, the machine may receive inputs from a user through user interface components 785 and execute appropriate functions, such as browsing functions by interpreting these inputs using processor 755.

It may be appreciated that example systems 700 and 750 may have more than one processor 710 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A method, comprising:
identifying, by a server system, an active computing environment comprising one or more files, the active computing environment selected from a group comprising an SAP HANA instance, an SAP application server instance, or an SAP central service instance;
generating, by the server system, a target computing environment corresponding to the active computing environment, the target computing environment being substantially similar to the active computing environment;
synchronizing, by the server system, files from the active computing environment to the target computing environment; and
routing, by the server system, users from the active computing environment to the target computing environment following synchronization of the files from the active computing environment to the target computing environment with minimal downtime.

2. The method of claim 1, wherein routing the users from the active computing environment to the target computing environment comprises:
reconfiguring a computing network comprising the active computing environment and the target computing environment.

3. The method of claim 1, further comprising:
causing, by the server system, the active computing environment to shut down following routing of the users from the active computing environment to the target computing environment.

4. The method of claim 1, wherein the target computing environment is generated responsive to detecting an upgrade or a patch to an operating system underlying the active computing environment.

5. The method of claim 1, wherein the target computing environment is generated responsive to detecting a request to vertically scale underlying infrastructure of the active computing environment.

6. The method of claim 1, wherein the target computing environment is generated responsive to changing an underlying hardware of the active computing environment.

7. The method of claim 1, further comprising:
testing, by the server system, operations in the target computing environment prior to routing the users from the active computing environment to the target computing environment.

8. A non-transitory computer readably medium comprising one or more sequences of instructions, which, when executed by a processor, causes a server system to perform operations comprising:
identifying an active computing environment comprising one or more files, the active computing environment selected from a group comprising an SAP HANA instance, an SAP application server instance, or an SAP central service instance;
generating a target computing environment corresponding to the active computing environment, the target computing environment being substantially similar to the active computing environment:
synchronizing files from the active computing environment to the target computing environment; and
routing users from the active computing environment to the target computing environment following synchronization of the files from the active computing environment to the target computing environment with minimal downtime.

9. The non-transitory computer readably medium of claim 8, wherein routing the users from the active computing environment to the target computing environment comprises:
reconfiguring a computing network comprising the active computing environment and the target computing environment.

10. The non-transitory computer readably medium of claim 8, wherein the system server:
causes the active computing environment to shut down following routing of the users from the active computing environment to the target computing environment.

11. The non-transitory computer readably medium of claim 8, wherein the target computing environment is generated responsive to detecting an upgrade or a patch to an operating system underlying the active computing environment.

12. The non-transitory computer readably medium of claim 8, wherein the target computing environment is generated responsive to detecting a request to vertically scale underlying infrastructure of the active computing environment.

13. The non-transitory computer readably medium of claim 8, wherein the target computing environment is generated responsive to changing an underlying hardware of the active computing environment.

14. The non-transitory computer readably medium of claim 8, wherein the system server:
tests operations in the target computing environment prior to routing the users from the active computing environment to the target computing environment.

15. A system, comprising:
a processor; and
a memory comprising programming instruction stored thereon, which, when executed by the processor, causes the system to perform operations comprising:
identifying an active computing environment comprising one or more files, the active computing environment selected from a group comprising an SAP HANA instance, an SAP application server instance, or an SAP central service instance;
generating a target computing environment corresponding to the active computing environment, the target computing environment being substantially similar to the active computing environment;
synchronizing files from the active computing environment to the target computing environment; and
routing users from the active computing environment to the target computing environment following synchronization of the files from the active computing environment to the target computing environment with minimal downtime.

16. The system of claim 15, wherein routing the users from the active computing environment to the target computing environment comprises:
reconfiguring a computing network comprising the active computing environment and the target computing environment.

17. The system of claim 15, further comprising:
causing the active computing environment to shut down following routing of the users from the active computing environment to the target computing environment.

18. The system of claim 15, wherein the target computing environment is generated responsive to detecting an upgrade or a patch to an operating system underlying the active computing environment.

19. The system of claim 15, wherein the target computing environment is generated responsive to detecting a request to vertically scale underlying infrastructure of the active computing environment.

20. The system of claim 15, wherein the target computing environment is generated responsive to changing an underlying hardware of the active computing environment.
